(19) United States
(12) Patent Application Publication
(10) Pub. No.: US 2025/0164780 A1
(43) Pub. Date: May 22, 2025

(54) LIGHT SCANNING APPARATUS

(71) Applicant: CANON KABUSHIKI KAISHA, Tokyo (JP)

(72) Inventor: Ryota SATO, Tochigi (JP)

(21) Appl. No.: 18/945,661

(22) Filed: Nov. 13, 2024

(30) Foreign Application Priority Data
Nov. 22, 2023 (JP) 2023-197828

(51) Int. Cl. G02B 26/10; G03G 15/04

(52) U.S. Cl. CPC G02B 26/105; G03G 15/0409

(57) ABSTRACT

Provided is a light scanning apparatus including a deflecting unit deflecting a light flux from a light source to scan a scanned surface in a main scanning direction, an imaging optical system including at least one optical element guiding light flux deflected by a deflecting surface of deflecting unit to scanned surface, and a reflecting element reflecting light flux. On an optical path of light flux from deflecting unit to scanned surface, reflecting element is arranged between deflecting unit and an optical element closest to deflecting unit among at least one optical element included in imaging optical system. An optical path length between an on-axis deflection point of deflecting surface and scanned surface on an optical axis of imaging optical system is equal to or less than a distance between outermost off-axis image heights on scanned surface.

### BACKGROUND

### Technical Field

The present disclosure relates to a light scanning apparatus, for example, to a light scanning apparatus suitable for use in an image forming apparatus such as a laser beam printer, a digital copying machine, or a multifunction printer.

### Description of the Related Art

Hitherto, as disclosed in, for example, Japanese Patent Application Laid-Open No. 2008-145717, there has been known a light scanning apparatus in which downsizing is achieved by arranging a reflecting element between a deflecting unit and an optical element that is closest to the deflecting unit in at least one optical element included in an imaging optical system.

However, in the light scanning apparatus as disclosed in Japanese Patent Application Laid-Open No. 2008-145717, no discussion has been made about an optical path length between the deflecting unit and a scanned surface, and the downsizing is insufficient.

### SUMMARY

In view of the foregoing, the present disclosure has an object to provide a sufficiently-downsized light scanning apparatus.

According to the embodiments, there is provided a light scanning apparatus including: a deflecting unit configured to deflect a first light flux from a first light source to scan a first scanned surface in a main scanning direction; a first imaging optical system including at least one optical element configured to guide the first light flux deflected by a first deflecting surface of the deflecting unit to the first scanned surface; and a first reflecting element configured to reflect the first light flux. On an optical path of the first light flux from the deflecting unit to the first scanned surface, the first reflecting element is arranged between the deflecting unit and a first optical element closest to the deflecting unit in the at least one optical element included in the first imaging optical system. A first optical path length between a first on-axis deflection point of the first deflecting surface and the first scanned surface on an optical axis of the first imaging optical system is equal to or less than a first distance between outermost off-axis image heights on the first scanned surface.

Further features of the present disclosure will become apparent from the following description of exemplary embodiments with reference to the attached drawings.

### BRIEF DESCRIPTION OF THE DRAWINGS

FIG. 1A is a schematic developed view in a main scanning cross section of a light scanning apparatus according to a first embodiment of the present invention.

FIG. 1B is a schematic partial sub-scanning cross sectional view of the light scanning apparatus according to the first embodiment.

FIG. 1C is a schematic partial sub-scanning cross sectional view of the light scanning apparatus according to the first embodiment.

FIG. 2 is a graph for showing partial magnification deviation at each image height in the light scanning apparatus according to the first embodiment.

FIG. 3A is a graph for showing image height dependence of a main scanning direction LSF depth center position on a scanned surface in the light scanning apparatus according to the first embodiment.

FIG. 3B is a graph for showing image height dependence of a sub-scanning direction LSF depth center position on the scanned surface in the light scanning apparatus according to the first embodiment.

FIG. 4A is a schematic developed view in a main scanning cross section of a light scanning apparatus according to a second embodiment of the present invention.

FIG. 4B is a schematic partial sub-scanning cross sectional view of the light scanning apparatus according to the second embodiment.

FIG. 4C is a schematic partial sub-scanning cross sectional view of the light scanning apparatus according to the second embodiment.

FIG. 5 is a graph for showing partial magnification deviation at each image height in the light scanning apparatus according to the second embodiment.

FIG. 6A is a graph for showing image height dependence of a main scanning direction LSF depth center position on a first scanned surface in the light scanning apparatus according to the second embodiment.

FIG. 6B is a graph for showing image height dependence of a sub-scanning direction LSF depth center position on the first scanned surface in the light scanning apparatus according to the second embodiment.

FIG. 7A is a schematic developed view in a main scanning cross section of a light scanning apparatus according to a third embodiment of the present invention.

FIG. 7B is a schematic partial sub-scanning cross sectional view of the light scanning apparatus according to the third embodiment.

FIG. 7C is a schematic partial sub-scanning cross sectional view of the light scanning apparatus according to the third embodiment.

FIG. 8 is a graph for showing partial magnification deviation at each image height in the light scanning apparatus according to the third embodiment.

FIG. 9A is a graph for showing image height dependence of a main scanning direction LSF depth center position on a scanned surface in the light scanning apparatus according to the third embodiment.

FIG. 9B is a graph for showing image height dependence of a sub-scanning direction LSF depth center position on the scanned surface in the light scanning apparatus according to the third embodiment.

FIG. 10 is a sub-scanning cross sectional view of a main part of an image forming apparatus according to the present embodiments.

### DESCRIPTION OF THE EMBODIMENTS

A light scanning apparatus according to the present embodiments is described in detail below with reference to the accompanying drawings. Some of the drawings referred to below may be drawn in scales different from the actual scale for easier understanding of the present disclosure.

In the following description, a main scanning direction refers to a direction perpendicular to a rotational axis of a deflecting element 104 and to an optical axis of imaging optical system 85 (a direction to which a light flux is deflected by the deflecting element 104), and a sub-scanning direction refers to a direction parallel to the rotational axis of the deflecting element 104.

Further, a main scanning cross section refers to a cross section perpendicular to the sub-scanning direction, and a sub-scanning cross section refers to a cross section perpendicular to the main scanning direction.

In the following, a direction parallel to the optical axis of imaging optical system 85, the main scanning direction, and the sub-scanning direction are defined as an X-direction, a Y-direction, and a Z-direction, respectively.

### First Embodiment

Hitherto, in order to downsize a product such as an image forming apparatus on which a light scanning apparatus is mounted, there has been used a configuration in which an optical path of a light flux deflected by a deflecting unit is fold by a folding mirror in the light scanning apparatus.

In addition, there have also been proposed various technologies for downsizing a housing itself in which each optical element forming the light scanning apparatus is accommodated by arranging the folding mirror between the deflecting unit and an optical element (imaging optical element) that is closest to the deflecting unit.

However, in the related-art light scanning apparatus in which the folding mirror is arranged between the deflecting unit and the optical element that is closest to the deflecting unit, no discussion has been made about an optical path length between the deflecting unit and a scanned surface, that is, an optical path length of an imaging optical system, so that the downsizing is insufficient.

In view of the foregoing, the present embodiments have an object to provide a light scanning apparatus capable of achieving sufficient downsizing by reducing the optical path length in the imaging optical system.

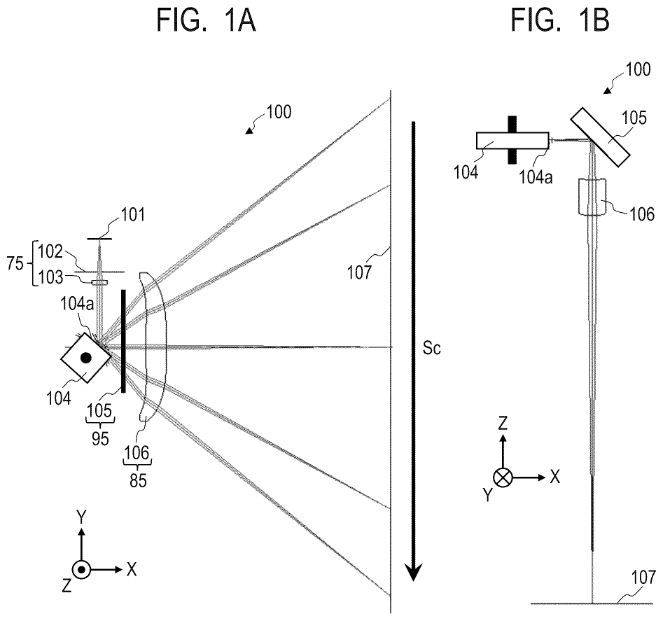

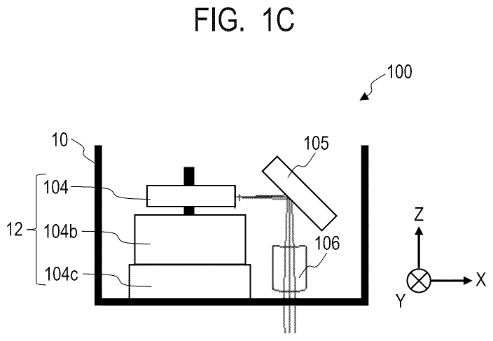

FIG. 1A shows a schematic developed view in the main scanning cross section of a light scanning apparatus 100 according to a first embodiment of the present invention.

Further, each of FIG. 1B and FIG. 1C shows a schematic partial sub-scanning cross sectional view of the light scanning apparatus 100 according to the first embodiment.

The light scanning apparatus 100 according to the present embodiment includes a housing 10, a deflecting element unit 12 (deflecting unit), a light source 101 (first light source), a stop 102, an incident optical element 103 (first incident optical element), a folding mirror 105 (first reflecting element), and an optical element 106.

In the light scanning apparatus 100 according to the present embodiment, the stop 102 and the incident optical element 103 form an incident optical system 75 (first incident optical system), and the optical element 106 forms the imaging optical system 85 (first imaging optical system).

Further, in the light scanning apparatus 100 according to the present embodiment, the folding mirror 105 forms a reflecting optical system 95 (first reflecting optical system).

That is, in the light scanning apparatus 100 according to the present embodiment, the imaging optical system 85 consists of only the optical element 106, in other words, is formed by a single optical element 106.

However, the present invention is not limited thereto. In the light scanning apparatus 100 according to the present embodiment, the imaging optical system 85 may be formed by at least one optical element.

Further, in the light scanning apparatus 100 according to the present embodiment, the reflecting optical system 95 for reflecting a light flux deflected by the deflecting element unit 12 consists of only the folding mirror 105, in other words, is formed by a single folding mirror 105.

That is, in the light scanning apparatus 100 according to the present embodiment, a folding mirror other than the folding mirror 105 is prevented from being arranged on an optical path of the light flux from the deflecting element unit 12 to a scanned surface 107.

The housing 10 accommodates the optical elements described above forming the light scanning apparatus 100 according to the present embodiment.

For example, a semiconductor laser can be used as the light source 101, and the number of light emitting portions of the light source 101 may be one, and may be two or more.

The stop 102 includes an elliptical aperture portion, and limits a light flux width in each of the main scanning direction and the sub-scanning direction of the light flux (first light flux) emitted from the light source 101.

The incident optical element 103 has a positive refractive power in the main scanning cross section, and converts the light flux that has passed through the stop 102 into a convergent light flux in the main scanning cross section.

As described above, by converting the light flux emitted from the light source 101 into the convergent light flux in the main scanning cross section, both of a short optical path and optical performance can be achieved with good balance in the imaging optical system 85 formed only of a single optical element 106.

Further, the incident optical element 103 has a positive refractive power in the sub-scanning cross section, and condenses the light flux that has passed through the stop 102 in the vicinity of a deflecting surface 104a of the deflecting element 104 so that a line image long in the main scanning direction is formed in the vicinity of the deflecting surface 104a.

In the light scanning apparatus 100 according to the present embodiment, in the main scanning cross section, the light flux width of the light flux at the time of entering the deflecting element 104 is smaller than the width of the deflecting surface 104a of the deflecting element 104.

The deflecting element unit 12 includes the deflecting element 104, a motor 104b (driving unit), and a motor substrate 104c (driving unit). The deflecting element 104 includes a plurality of deflecting surfaces 104a. The motor 104b and the motor substrate 104c are required for rotating the deflecting element 104 about a rotational axis.

In addition, the motor 104b rotates the deflecting element 104 at a constant speed in the deflecting element unit 12.

The folding mirror 105 is, for example, a planar mirror. In addition, the folding mirror 105 is arranged on an optical path of the light flux deflected by the deflecting element unit 12, between the deflecting element unit 12 and the optical element 106 that is closest to the deflecting element unit 12 in the at least one optical element included in the imaging optical system 85.

The folding mirror 105 reflects the light flux deflected by the deflecting surface 104a of the deflecting element 104 toward the optical element 106 without changing the degree of convergence.

In the light scanning apparatus 100 according to the present embodiment, the folding mirror 105 folds the optical path of the light flux deflected by the deflecting surface 104a of the deflecting element 104 by 90 degrees in the sub-scanning cross section.

In other words, in the light scanning apparatus 100 according to the present embodiment, an incident angle of the light flux to a reflecting surface of the folding mirror 105 (angle formed by an incident direction of the light flux with respect to the normal to the reflecting surface) is 45 degrees.

The optical element 106 includes two optical surfaces (lens surfaces) of an incident surface (first surface) and an exit surface (second surface), and has a positive refractive power in each of the main scanning cross section and the sub-scanning cross section.

With this configuration, the light flux that has been incident on the optical element 106 is condensed in both of the main scanning cross section and the sub-scanning cross section, and thus a spot-like image is formed in the vicinity of the scanned surface 107 (first scanned surface).

In addition, the optical element 106 is configured such that the light flux deflected by the deflecting surface 104a of the deflecting element 104 in the main scanning cross section scans the scanned surface 107 with a desired scanning characteristic.

Further, the optical element 106 allows an optically conjugate relationship to be set between the vicinity of the deflecting surface 104a of the deflecting element 104 and the vicinity of the scanned surface 107 in the sub-scanning cross section.

This setting allows so-called optical facet angle error compensation of reducing deviation of a scanning position in the sub-scanning direction on the scanned surface 107 when the deflecting surface 104a tilts.

In the light scanning apparatus 100 according to the present embodiment, the light flux emitted from the light source 101 is guided by the incident optical system 75 to the deflecting surface 104a (first deflecting surface) of the deflecting element 104.

Next, the light flux deflected by the deflecting surface 104a of the deflecting element 104 is reflected by the folding mirror 105, and is then guided (condensed) by the optical element 106 onto the scanned surface 107.

In addition, the motor 104b rotates the deflecting element 104 at a constant speed so that the light flux scans the scanned surface 107 in an arrow Sc direction. Thus, an electrostatic latent image is formed on the scanned surface 107.

In the light scanning apparatus 100 according to the present embodiment, an angle between an optical axis of the incident optical system 75 and an optical axis of the imaging optical system 85 in the main scanning cross section is 90 degrees.

As described above, in the light scanning apparatus 100 according to the present embodiment, the folding mirror 105 is arranged on the upstream side of the optical element 106 on the optical path of the light flux deflected by the deflecting surface 104a of the deflecting element 104.

In this manner, as compared to a general configuration in which the folding mirror 105 is arranged on the downstream side of the optical element 106 on the optical path, the optical path length between the deflecting surface 104a and the reflecting surface of the folding mirror 105 can be reduced.

That is, downsizing of the housing 10 can be achieved by reducing the size in the main scanning cross section of the light scanning apparatus 100 according to the present embodiment.

Further, in the light scanning apparatus 100 according to the present embodiment, as illustrated in FIG. 1C, the folding mirror 105 reflects the incident light flux toward a lower side in the sub-scanning direction, that is, toward a side on which the motor 104b and the motor substrate 104c are arranged with respect to the deflecting element 104.

In this manner, the optical element 106 can be arranged in an inefficient space formed by not the deflecting element 104 but the motor 104b and the motor substrate 104c in the deflecting element unit 12.

That is, further downsizing of the housing 10 can be achieved by also reducing the size in the sub-scanning cross section of the light scanning apparatus 100 according to the present embodiment.

Further, in the light scanning apparatus 100 according to the present embodiment, the light flux deflected by the deflecting surface 104a of the deflecting element 104 at a predetermined scanning angle is guided by a synchronous detection optical system (not shown) to a synchronous detection sensor. Thus, a synchronous detection signal is generated.

In addition, the rotation speed of the deflecting element 104 is controlled to be constant based on the generated synchronous detection signal.

A plastic molded lens formed by injection molding is used as each of the incident optical element 103 and the optical element 106 provided in the light scanning apparatus 100 according to the present embodiment, but the present invention is not limited thereto. A glass molded lens may be used instead.

It is easy to form an aspherical shape on the molded lens, and the molded lens is suitable for mass production. Thus, the use of the molded lenses as the incident optical element 103 and the optical element 106 can improve productivity and optical performance.

Further, the folding mirror 105 provided in the light scanning apparatus 100 according to the present embodiment is formed by forming a film as the reflecting surface on a general long piece of glass, but the present invention is not limited thereto.

That is, the folding mirror 105 may be formed by forming a film as the reflecting surface on a member formed through plastic molding, or by performing mirror-like finishing on a metal such as aluminum.

Further, the reflecting surface of the folding mirror 105 is formed so as to have a planar shape, but may be formed so as to have a spherical surface or other shapes.

Next, specification values, refractive indices and surface intervals of the respective optical elements, and lens surface shapes of the incident optical element 103 and the optical element 106, of the light scanning apparatus 100 according to the present embodiment are shown in Table 1, Table 2, and Table 3 below, respectively.

TABLE 1

| | Parameter | |
|---|---|---|
| Item | and Unit | Value |
| Angle between optical axis of incident | Ψ [rad] | 1.571 |
| optical system 75 and optical axis of | | |
| imaging optical system 85 | | |
| Scanning width on scanned surface 107 | h [mm] | 214 |
| (distance between outermost off-axis image | | |
| heights) | | |
| Imaging coefficient at on-axis image height | KK [mm/rad] | 111.318 |
| Scanning characteristic coefficient | α [mm/rad³] | 14.929 |
| Maximum scanning angle | θmax [rad] | 0.873 |
| Number of deflecting surfaces 104a of | [Surface] | 4 |
| deflecting element 104 | | |
| Rotation center position in optical axis | Px [mm] | −5.89 |
| direction of deflecting element 104 | | |
| Rotation center position in main scanning | Py [mm] | −4.11 |
| direction of deflecting element 104 | | |
| Circumscribed circle radius in main | [mm] | 10 |
| scanning cross section of deflecting | | |
| element 104 | | |
| Diameter of stop 102 (main scanning | Am × As | 1.644 × |
| direction × sub-scanning direction) | [mm × mm] | 1.606 |
| Optical path length between on-axis | Tc [mm] | 125 |
| deflection point and scanned surface 107 | | |
| Reflection angle of light flux by folding | η [rad] | 1.571 |
| mirror 105 | | |
| Optical path length between on-axis | Dm [mm] | 229.027 |
| deflection point and natural convergence | | |
| point | | |
| Focal length in main scanning cross section | fm [mm] | 194.026 |
| of optical element 106 | | |
| Focal length in sub-scanning cross section | fs [mm] | 21.081 |
| of optical element 106 | | |
| Optical path length between on-axis | DR2 [mm] | 28.800 |
| deflection point and exit surface of optical | | |
| element 106 | | |

TABLE 2

| | | | Refractive | | | | | | |
|---|---|---|---|---|---|---|---|---|---|
| | | Surface | index | | | | | | |
| Surface | Optical | interval | (λ = 790 | Coordinates of surface vertex | | | Direction cosine of optical axis | | |
| number | surface | [mm] | nm) | tc(x) | tc(y) | tc(z) | gx(x) | gx(y) | gx(z) |
| 1 | Light source 101 | 0.250 | 1.511 | 0.000 | 46.500 | 0.000 | 0.000 | 1.000 | 0.000 |
| 2 | Glass cover | 13.860 | 1.000 | 0.000 | 46.250 | 0.000 | 0.000 | 1.000 | 0.000 |
| | for laser chip | | | | | | | | |
| 3 | Stop 102 | 3.720 | 1.000 | 0.000 | 32.390 | 0.000 | 0.000 | 1.000 | 0.000 |
| 4 | Incident surface of | 2.000 | 1.529 | 0.000 | 28.670 | 0.000 | 0.000 | 1.000 | 0.000 |
| | incident optical | | | | | | | | |
| | element 103 | | | | | | | | |
| 5 | Exit surface of | 26.670 | 1.000 | 0.000 | 26.670 | 0.000 | 0.000 | 1.000 | 0.000 |
| | incident optical | | | | | | | | |
| | element 103 | | | | | | | | |
| 6 | Deflecting surface | 10.000 | 1.000 | 0.000 | 0.000 | 0.000 | 0.707 | 0.707 | 0.000 |
| | 104a of deflecting | | | | | | | | |
| | element 104 (in | | | | | | | | |
| | on-axis light flux | | | | | | | | |
| | deflection) | | | | | | | | |
| 7 | Folding mirror 105 | 9.800 | 1.000 | 10.000 | −0.079 | 0.000 | 0.707 | 0.000 | 0.707 |
| 8 | Incident surface of | 9.000 | 1.529 | 10.000 | −0.079 | −9.800 | 0.000 | 0.000 | 1.000 |
| | optical element 106 | | | | | | | | |
| 9 | Exit surface of | 96.200 | 1.000 | 10.000 | −0.079 | −18.800 | 0.000 | 0.000 | 1.000 |
| | optical element 106 | | | | | | | | |
| 10 | Scanned surface 107 | — | 1.000 | 10.000 | −0.079 | −115.000 | 0.000 | 0.000 | 1.000 |

TABLE 3

| | Aspherical coefficient | | | | | | |
|---|---|---|---|---|---|---|---|
| | | | | Optical element 106 | | | |
| | | Incident optical | | Incident surface | | Exit surface | |
| | | element 103 | | | Side | | Side |
| | | Incident | Exit | Light source | opposite to | Light source | opposite to |
| | Coefficient | surface | surface | side | light source | side | light source |
| Meridional | R | ∞ | 3.3571E+01 | −1.3588E+02 | | 4.0897E+02 | |
| line | K | — | — | −1.1138E+01 | | 1.6296E+02 | |
| | B3 | — | — | 2.5919E−05 | | 2.9690E−05 | |
| | B4 | — | — | 1.1493E−05 | 1.5490E−05 | 5.4747E−06 | 8.7940E−06 |
| | B5 | — | — | — | — | — | — |
| | B6 | — | — | −1.4759E−08 | −1.9455E−08 | −1.2390E−09 | −4.1035E−09 |
| | B7 | — | — | — | — | — | — |
| | B8 | — | — | 1.3013E−11 | 1.6840E−11 | −1.9352E−12 | 2.6303E−13 |
| | B9 | — | — | — | — | — | — |
| | B10 | — | — | −3.0993E−15 | −4.7941E−15 | 2.6853E−15 | 1.6610E−15 |
| Sagittal | r | ∞ | 1.2405E+01 | 5.6720E+01 | | 9.8261E+00 | |
| line | E1 | — | — | 1.1052E−03 | | 6.1383E−04 | |
| | E2 | — | — | 1.4161E−04 | | −2.3125E−05 | |
| | E3 | — | — | −3.3561E−06 | | −8.5529E−07 | |
| | E4 | — | — | −9.9888E−07 | | −3.3785E−08 | |
| | E5 | — | — | 3.6274E−09 | | 4.9031E−10 | |
| | E6 | — | — | 1.5148E−09 | | −6.5671E−11 | |
| | E7 | — | — | 2.1275E−13 | | −2.0722E−13 | |
| | E8 | — | — | −6.6666E−13 | | −5.2878E−14 | |
| | E9 | — | — | — | | 9.6209E−16 | |
| | E10 | — | — | — | | 1.8070E−16 | |
| Additional | C3 | −2.5937E−02 | — | — | — | — | — |
| shape | C5 | −2.2164E−02 | — | — | — | — | — |

The incident optical element 103 provided in the light scanning apparatus 100 according to the present embodiment has an incident surface that is a diffractive surface with a diffraction grating formed therein.

In addition, the incident optical element 103 is formed by injection molding that uses a plastic material. Thus, the light scanning apparatus 100 employs a so-called temperature-compensated optical system in which changes in refractive power due to environmental variation are compensated with changes in diffractive power that accompany changes in wavelength of the semiconductor laser.

Specifically, the diffractive surface formed on the incident surface of the incident optical element 103 is defined by a phase function expressed by Expression (1) below.

$$ϕ = \frac{2 π M}{λ} ( {C}_{3} {Z}^{2} \times {C}_{5} {Y}^{2} ) \qquad ( 1 )$$

In Expression (1), ϕ represents the phase function and M represents order of diffraction and, because the light scanning apparatus 1 according to the present embodiment uses first-order diffraction light, the order of diffraction M is 1.

Further, λ is a wavelength of the light flux emitted from the light source 101, and the wavelength λ is 790 nm in the light scanning apparatus 100 according to the present embodiment.

Further, the optical element 106 provided in the light scanning apparatus 100 according to the present embodiment has an incident surface and an exit surface each of which has a shape in the main scanning cross section (meridional shape) which is an aspherical shape defined by a tenth-order polynomial function expressed by Expression (2) below.

$$X = \frac{\frac{{Y}^{2}}{R}}{1 + \sqrt{1 - ( 1 + K ) {( \frac{Y}{R} )}^{2}}} + {\sum }_{i = 1}^{10} {B}_{i} {Y}^{i} \qquad ( 2 )$$

In Expression (2), an intersection between each optical surface of the optical element 106 and the optical axis is set as an origin, a direction parallel to the optical axis is set as the X-direction, and a direction perpendicular to the optical axis in the main scanning cross section is set as the Y-direction.

Further, in Expression (2), R represents a curvature radius of a meridional line, K represents an eccentricity, and B₁ to B₁₀ represent aspherical coefficients.

Further, among the aspherical coefficients B₁ to B₁₀, a coefficient having different numerical values between the light source side (Y-direction plus side) and the side opposite to the light source (Y-direction minus side) is represented by numerical values on the respective sides.

Further, a shape in the sub-scanning cross section (sagittal shape) of each of the incident surface and the exit surface of the optical element 106 provided in the light scanning apparatus 100 according to the present embodiment is expressed by Expression (3) below.

$$S = \frac{\frac{{Z}^{2}}{{r}^{′}}}{1 + \sqrt{1 - {( \frac{Z}{{r}^{′}} )}^{2}}} \qquad ( 3 )$$

In Expression (3), S represents a shape (sagittal shape) in a cross section that includes a normal line of a meridional line at a predetermined position in the main scanning direction and that is perpendicular to the main scanning cross section.

A curvature radius r′ in the sub-scanning cross section (a curvature radius of a sagittal line) at a position spaced apart from the optical axis by Y in the main scanning direction is expressed by Expression (4) below.

$$\frac{1}{{r}^{′}} = \frac{1}{r} + {\sum }_{i = 1}^{10} {E}_{i} {Y}^{i} \qquad ( 4 )$$

In Expression (4), “r” represents the curvature radius of the sagittal line on the optical axis, and E₁ to E₁₀ represent variation coefficients of the sagittal line.

As expressed in Expression (4), the curvature radius of the sagittal line r′ changes depending on the position Y in the main scanning direction.

In the light scanning apparatus 100 according to the present embodiment, the shape of the optical surface of each optical element is defined by the functions expressed by Expressions (1) to (4) above, but are not limited thereto and may be defined by other functions.

Next, scanning with non-constant speed in the light scanning apparatus 100 according to the present embodiment is described.

The scanning characteristic of the imaging optical system 85 provided in the light scanning apparatus 100 according to the present embodiment is expressed by Expression (5) below.

$$Y = KK \cdot θ + α \cdot {θ}^{3} \qquad ( 5 )$$

In Expression (5), 0 represents a scanning angle by the deflecting element 104, and Y represents a coordinate (image height) in the main scanning direction of a condensed position on the scanned surface 107 of the light flux deflected at the scanning angle θ.

Further, in Expression (5), KK represents an imaging coefficient at the on-axis image height, and a represents a scanning characteristic coefficient for determining the scanning characteristic of the imaging optical system 85.

In the light scanning apparatus 100 according to the present embodiment, the on-axis image height is an image height (Y=0) on the optical axis of the imaging optical system 85, and corresponds to the scanning angle θ=0.

Further, the off-axis image height is an image height other than the on-axis image height (Y≠0), and corresponds to the scanning angle θ≠0. In addition, the outermost off-axis image height is an image height given when the scanning angle θ is maximum.

Further, the imaging coefficient KK corresponds to a coefficient “f” in the scanning characteristic (fθ characteristic) Y=fθ at the time when a completely parallel light flux is incident on the imaging optical system 85.

That is, the imaging coefficient KK is a coefficient for establishing a proportional relationship between the image height Y and the scanning angle θ similarly to the fθ characteristic at the time when a light flux other than the completely parallel light flux is incident on the imaging optical system 85.

In the light scanning apparatus 100 according to the present embodiment, the convergent light flux in the main scanning cross section is caused to be incident on the imaging optical system 85, and the imaging coefficient KK in the scanning characteristic of the imaging optical system 85 is set depending on incidence of the convergent light flux.

Further, in the light scanning apparatus 100 according to the present embodiment, the scanning characteristic coefficient α is set to a positive value.

For example, when the value of the scanning characteristic coefficient α is 0, Expression (5) is expressed as Y=KK·θ, and hence the scanning characteristic of the imaging optical system 85 is the same as the scanning characteristic Y=fθ of a general imaging optical system.

Further, when both sides of Expression (5) are differentiated with respect to the scanning angle θ, a scanning speed of the light flux at a predetermined image height on the scanned surface 107 corresponding to a predetermined scanning angle θ is obtained as expressed by Expression (6) below.

$$\frac{dY}{d θ} = KK + 3 α \cdot {θ}^{2} \qquad ( 6 )$$

In addition, when both sides of Expression (6) are divided by the scanning speed dY/dθ=KK at the on-axis image height, Expression (7) below is obtained.

$$\frac{1}{KK} \cdot \frac{dY}{d θ} = 1 + \frac{3 α}{KK} \cdot {θ}^{2} \qquad ( 7 )$$

The right side of Expression (7) represents a deviation amount of the scanning speed at each off-axis image height with respect to the scanning speed at the on-axis image height, in other words, a deviation amount of a partial magnification at each off-axis image height with respect to a partial magnification at the on-axis image height, that is, partial magnification deviation.

Accordingly, when the value of the scanning characteristic coefficient α is other than 0 as in the imaging optical system 85 provided in the light scanning apparatus 100 according to the present embodiment, the scanning speed of the light flux differs between the on-axis image height and the off-axis image height.

In addition, in the light scanning apparatus 100 according to the present embodiment, the imaging optical system 85 is set so as to have such a scanning characteristic that the value of the scanning characteristic coefficient α is not 0. Thus, the optical path of the imaging optical system 85 is reduced.

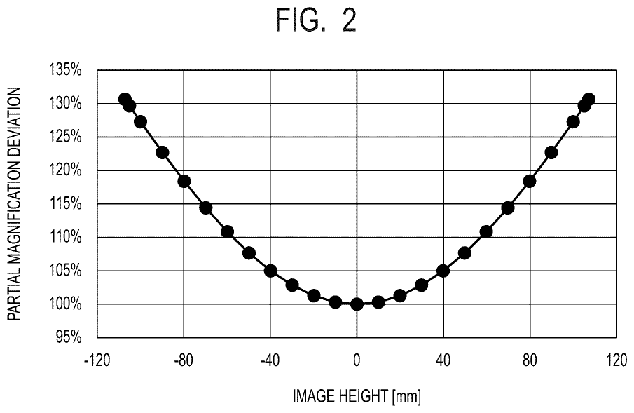

FIG. 2 shows partial magnification deviation at each image height in the light scanning apparatus 100 according to the present embodiment.

Specifically, FIG. 2 shows a value of a ratio of a partial magnification at each off-axis image height to a partial magnification at the on-axis image height.

As shown in FIG. 2, in the light scanning apparatus 100 according to the present embodiment, the maximum partial magnification deviation, specifically, the partial magnification deviation of about 130.6% is caused at the outermost off-axis image height.

That is, in the light scanning apparatus 100 according to the present embodiment, the scanning characteristic of the imaging optical system 85 is set so that the scanning speed at each off-axis image height becomes larger than the scanning speed at the on-axis image height.

In other words, in the light scanning apparatus 100 according to the present embodiment, the scanning speed of the light flux on the scanned surface 107 is monotonically increased from the on-axis image height toward the outermost off-axis image height.

As described above, in the light scanning apparatus 100 according to the present embodiment, the incident optical element 103 has a positive refractive power in the main scanning cross section, and converts the incident light flux into a convergent light flux in the main scanning cross section.

Specifically, in the light scanning apparatus 100 according to the present embodiment, when the imaging optical system 85 is not provided virtually, an optical path length Dₘ between the on-axis deflection point (first on-axis deflection point) and a position at which the on-axis light flux is naturally converged in the main scanning cross section is about 229 mm.

In this case, the on-axis light flux refers to a light flux for scanning the on-axis image height on the scanned surface 107, and the on-axis deflection point refers to a deflection point of a principal ray of the on-axis light flux on the deflecting surface 104a of the deflecting element 104.

In the light scanning apparatus 100 according to the present embodiment, the degree of convergence in the main scanning cross section of the light flux achieved by the incident optical element 103 is set so as to be stronger than that in the related art. Thus, even with a short optical path, the optical performance can be kept satisfactory even when the optical element 106 is arranged so as to be spaced apart from the deflecting element 104.

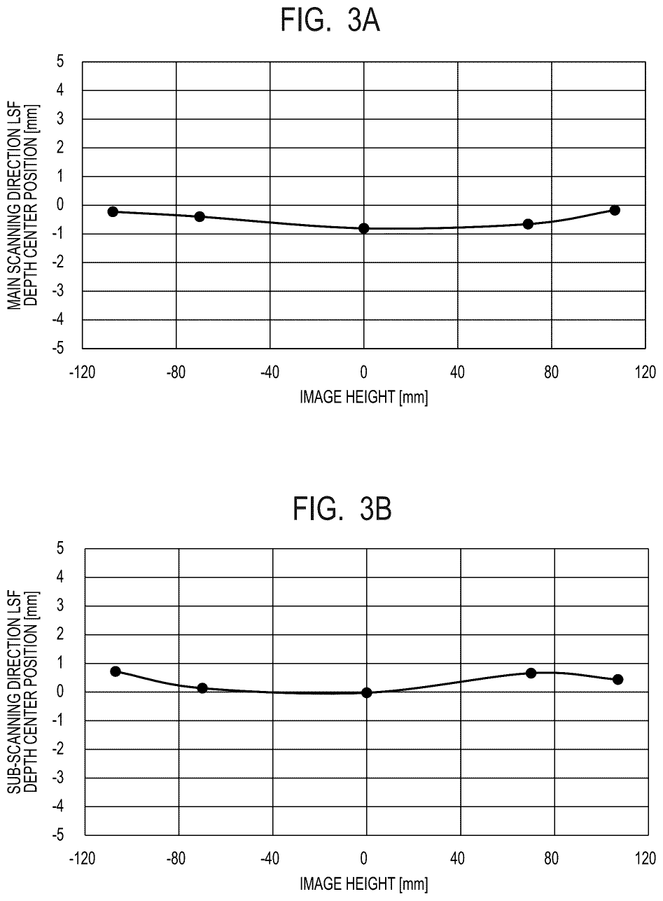

FIG. 3A and FIG. 3B show image height dependence of a main scanning direction line-spread function (LSF) depth center position and a sub-scanning direction LSF depth center position, respectively, on the scanned surface 107 in the light scanning apparatus 100 according to the present embodiment.

The main scanning direction LSF depth center position and the sub-scanning direction LSF depth center position here refer to center positions of regions in which LSF widths in the main scanning direction and the sub-scanning direction, respectively, are equal to or less than a slice level, when defocusing is performed in the optical axis direction in the vicinity of the scanned surface 107.

In the light scanning apparatus 100 according to the present embodiment, in both of the main scanning direction and the sub-scanning direction, the slice level is set to 120 m over entire image heights.

The LSF width in the main scanning direction and the LSF width in the sub-scanning direction refer to widths of slices of light amount profiles obtained by integrating spot profiles at each image height in the sub-scanning direction and the main scanning direction, respectively, when the light amount profiles are sliced at a position that is 13.5% of a maximum value.

As shown in FIG. 3A and FIG. 3B, the main scanning direction LSF depth center position and the sub-scanning direction LSF depth center position both fall within ±1 mm over all image heights, and this shows that excellent imaging performance is achieved in the light scanning apparatus 100 according to the present embodiment.

In the light scanning apparatus 100 according to the present embodiment, as shown in Table 1, an optical path length T_{c} (first optical path length) between the on-axis deflection point on the deflecting surface 104a of the deflecting element 104 and the scanned surface 107 along the optical axis of the imaging optical system 85 is equal to or less than a scanning width in the main scanning direction on the scanned surface 107, in other words, a distance “h” (first distance) between the outermost off-axis image heights of the scanned surface 107.

In this manner, sufficient downsizing can be achieved in the light scanning apparatus 100 according to the present embodiment.

Further, in the light scanning apparatus 100 according to the present embodiment, it is preferred that Inequality (8) below be satisfied.

$$0.5 \leq \frac{{T}_{c}}{h} \leq 1. \qquad ( 8 )$$

When TA/h exceeds the upper limit value in Inequality (8), the optical path length of the imaging optical system 85 becomes larger than the distance between the outermost off-axis image heights of the scanned surface 107, and hence it becomes difficult to sufficiently downsize the light scanning apparatus 100 according to the present embodiment.

Meanwhile, when TA/h falls below the lower limit value in Inequality (8), the optical path length of the imaging optical system 85 becomes excessively smaller than the distance between the outermost off-axis image heights of the scanned surface 107, and hence it becomes difficult to keep the imaging performance satisfactory in the light scanning apparatus 100 according to the present embodiment.

In the light scanning apparatus 100 according to the present embodiment, it is more preferred that Inequality (8a) below be satisfied.

$$0.5 \leq \frac{{T}_{c}}{h} \leq 0.7 \qquad ( 8 a )$$

Further, in the light scanning apparatus 100 according to the present embodiment, it is preferred that Inequalities (9), (10), and (11) below be satisfied.

$$0.5 \leq \frac{{D}_{m}}{{T}_{c}} \leq 2.5 \qquad ( 9 )$$

$$0.05 \leq \frac{{f}_{s}}{{f}_{m}} \leq 0.25 \qquad ( 10 )$$

$$0.15 \leq \frac{{D}_{R 2}}{{T}_{c}} \leq 0.5 \qquad ( 11 )$$

In Inequality (9), Dₘ represents an optical path length between the on-axis deflection point and a position (natural convergence point, first convergence point) at which the on-axis light flux deflected by the deflecting surface 104a of the deflecting element 104 is converged in the main scanning cross section when the imaging optical system 85 is not provided.

When Dₘ/T_{c} exceeds the upper limit value or falls below the lower limit value in Inequality (9), it becomes difficult to keep balance for sharing the refractive power in the imaging optical system 85, and it becomes difficult to keep the imaging performance satisfactory.

Further, when Dₘ/T_{c} falls below the lower limit value in Inequality (9), there also occurs a trouble of increasing sensitivity to irradiation position deviation in the main scanning direction caused by a mounting error of the deflecting element 104.

Further, in Inequality (10), “fₛ” and “fₘ” represent focal lengths in the sub-scanning cross section and the main scanning cross section, respectively, on the optical axis of the imaging optical system 85.

When fₛ/fₘ exceeds the upper limit value or falls below the lower limit value in Inequality (10), it becomes difficult to achieve such a shape that keeps balance with the optical performance in each of the main scanning cross section and the sub-scanning cross section of the optical element 106 forming the imaging optical system 85.

Further, in Inequality (11), D_{R2} represents an optical path length between the on-axis deflection point of the deflecting element 104 and the exit surface of the optical element 106 along the optical axis of the imaging optical system 85.

When D_{R2}/T_{c} exceeds the upper limit value in Inequality (11), the optical element 106 is excessively spaced apart from the deflecting element 104, and hence it becomes difficult to sufficiently downsize the light scanning apparatus 100 according to the present embodiment.

Meanwhile, when D_{R2}/T_{c} falls below the lower limit value in Inequality (11), the optical element 106 is excessively close to the deflecting element 104, and hence it becomes difficult to arrange the folding mirror 105.

In the light scanning apparatus 100 according to the present embodiment, it is more preferred that Inequalities (9a), (10a), and (11a) below be satisfied.

$$1. \leq \frac{{D}_{m}}{{T}_{c}} \leq 2.2 \qquad ( 9 a )$$

$$0.05 \leq \frac{{f}_{s}}{{f}_{m}} \leq 0.2 \qquad ( 10 a )$$

$$0.17 \leq \frac{{D}_{R 2}}{{T}_{c}} \leq 0.4 \qquad ( 11 a )$$

Further, in the light scanning apparatus 100 according to the present embodiment, it is preferred that Inequality (12) below be satisfied.

$$110. \leq \vert Δ Y \vert \leq 140. \qquad ( 12 )$$

In Inequality (12), ΔY (%) represents a value of a ratio of a partial magnification at the outermost off-axis image height to the partial magnification at the on-axis image height.

In the light scanning apparatus 100 according to the present embodiment, it is more preferred that Inequality (12a) below be satisfied.

$$120. \leq \vert Δ Y \vert \leq 135. \qquad ( 12 a )$$

In the light scanning apparatus 100 according to the present embodiment, T_{c}/h=0.58, Dₘ/T_{c}=1.83, and fₛ/fₘ=0.11 are satisfied, and thus Inequalities (8), (8a), (9), (9a), (10), and (10a) are satisfied.

Further, in the light scanning apparatus 100 according to the present embodiment, D_{R2}/T_{c}=0.23 and |ΔY|=130.6% are satisfied, and thus Inequalities (11), (11a), (12), and (12a) are satisfied.

As described above, in the light scanning apparatus 100 according to the present embodiment, the folding mirror 105 is arranged between the deflecting element unit 12 and the optical element 106 that is closest to the deflecting element unit 12 in the imaging optical system 85, and Inequality (8) is satisfied.

In this manner, the light scanning apparatus 100 that is sufficiently downsized by reducing the optical path can be provided.

In the light scanning apparatus 100 according to the present embodiment, a coupling lens and a cylindrical lens may be provided in place of the incident optical element 103.

### Second Embodiment

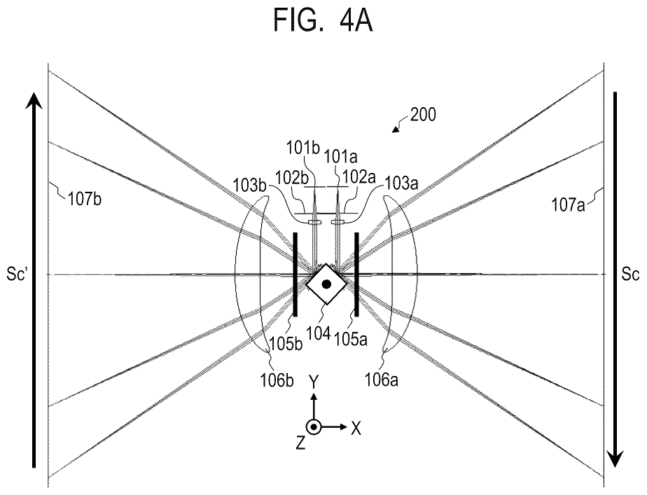

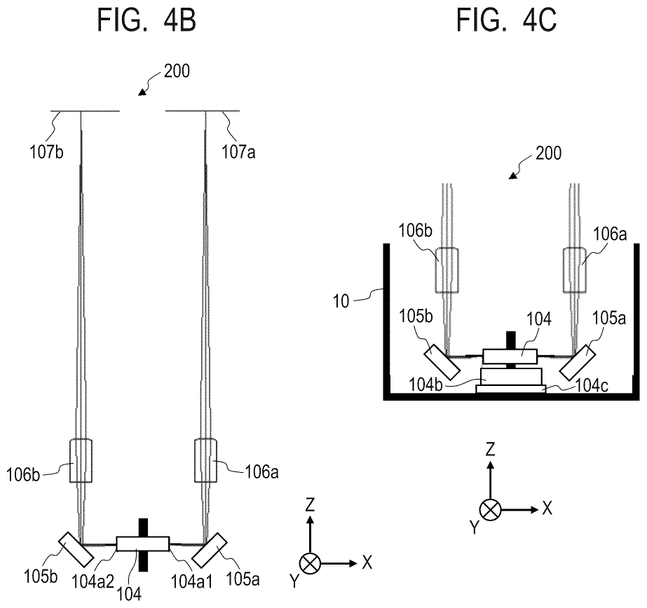

FIG. 4A shows a schematic developed view in the main scanning cross section of a light scanning apparatus 200 according to a second embodiment of the present invention.

Further, each of FIG. 4B and FIG. 4C shows a schematic partial sub-scanning cross sectional view of the light scanning apparatus 200 according to the second embodiment.

In the following, description of the same configuration as that of the light scanning apparatus 100 according to the first embodiment is omitted.

The light scanning apparatus 200 according to the present embodiment includes a housing 10, a deflecting element unit 12, first and second light sources 101a and 101b, and first and second stops 102a and 102b.

Further, the light scanning apparatus 200 according to the present embodiment includes first and second incident optical elements 103a and 103b, first and second folding mirrors 105a and 105b, and first and second optical elements 106a and 106b.

In the light scanning apparatus 200 according to the present embodiment, the first stop 102a and the first incident optical element 103a form a first incident optical system, and the second stop 102b and the second incident optical element 103b form a second incident optical system.

Further, in the light scanning apparatus 200 according to the present embodiment, the first optical element 106a forms a first imaging optical system, and the second optical element 106b (third optical element) forms a second imaging optical system.

Further, in the light scanning apparatus 200 according to the present embodiment, the first folding mirror 105a forms a first reflecting optical system, and the second folding mirror 105b (second reflecting element) forms a second reflecting optical system.

For example, a semiconductor laser can be used as each of the first and second light sources 101a and 101b, and the number of light emitting portions of each of the first and second light sources 101a and 101b may be one, and may be two or more.

Each of the first and second stops 102a and 102b includes an elliptical aperture portion, and limits a light flux width in each of the main scanning direction and the sub-scanning direction of each of first and second light fluxes emitted from the respective first and second light sources 101a and 101b.

The first and second incident optical elements 103a and 103b each have a positive refractive power in the main scanning cross section, and convert the respective first and second light fluxes that have passed through the first and second stops 102a and 102b into convergent light fluxes in the main scanning cross section.

In this manner, in the first and second imaging optical systems respectively formed of single first and second optical elements 106a and 106b, both of a short optical path and optical performance can be achieved with good balance.

Further, the first and second incident optical elements 103a and 103b each have a positive refractive power in the sub-scanning cross section.

Accordingly, the first and second light fluxes that have passed through the respective first and second stops 102a and 102b are condensed in the vicinities of first and second deflecting surfaces 104a1 and 104a2 of the deflecting element 104.

In this manner, line images long in the main scanning direction are formed in the vicinities of the first and second deflecting surfaces 104a1 and 104a2.

In the light scanning apparatus 200 according to the present embodiment, in the main scanning cross section, the light flux widths of the first and second light fluxes at the time of entering the deflecting element 104 are smaller than the respective widths of the first and second deflecting surfaces 104a1 and 104a2 of the deflecting element 104.

Each of the first and second folding mirrors 105a and 105b is, for example, a planar mirror. In addition, the first and second folding mirrors 105a and 105b reflect the respective first and second light fluxes deflected by the first and second deflecting surfaces 104a1 and 104a2 of the deflecting element 104 toward the respective first and second optical elements 106a and 106b without changing the degree of convergence.

The first and second folding mirrors 105a and 105b fold the respective optical paths of the first and second light fluxes deflected by the first and second deflecting surfaces 104a1 and 104a2 of the deflecting element 104 by 900 in the sub-scanning cross section.

The first and second optical elements 106a and 106b each include two optical surfaces (lens surfaces) of an incident surface (first surface) and an exit surface (second surface), and each have a positive refractive power in each of the main scanning cross section and the sub-scanning cross section.

In this manner, the first and second light fluxes that have been incident on the respective first and second optical elements 106a and 106b are condensed in both of the main scanning cross section and the sub-scanning cross section, and hence spot-like images are formed in the vicinities of first and second scanned surfaces 107a and 107b.

In addition, the first and second optical elements 106a and 106b are configured such that the first and second light fluxes deflected by the respective first and second deflecting surfaces 104a1 and 104a2 scan the respective first and second scanned surfaces 107a and 107b with desired scanning characteristics.

Further, the first and second optical elements 106a and 106b allow an optically conjugate relationship to be set between the vicinities of the first and second deflecting surfaces 104a1 and 104a2 of the deflecting element 104 and the vicinities of the first and second scanned surfaces 107a and 107b in the sub-scanning cross section.

This setting allows so-called optical facet angle error compensation of reducing deviation of a scanning position in the sub-scanning direction on the first and second scanned surfaces 107a and 107b at the time when the first and second deflecting surfaces 104a1 and 104a2 tilt.

In the light scanning apparatus 200 according to the present embodiment, the first light flux emitted from the first light source 101a is guided by the first incident optical system to the first deflecting surface 104a1 of the deflecting element 104.

Next, the first light flux deflected by the first deflecting surface 104a1 of the deflecting element 104 is reflected by the first folding mirror 105a, and is then guided (condensed) by the first optical element 106a onto the first scanned surface 107a.

In addition, the motor 104b rotates the deflecting element 104 at a constant speed so that the first light flux scans the first scanned surface 107a in an arrow Sc direction. Thus, an electrostatic latent image is formed on the first scanned surface 107a.

In the light scanning apparatus 200 according to the present embodiment, the second light flux exiting the second light source 101b is guided by the second incident optical system to the second deflecting surface 104a2 of the deflecting element 104.

Next, the second light flux deflected by the second deflecting surface 104a2 of the deflecting element 104 is reflected by the second folding mirror 105b, and is then guided (condensed) by the second optical element 106b onto the second scanned surface 107b.

In addition, the motor 104b rotates the deflecting element 104 at a constant speed so that the second light flux scans the second scanned surface 107b in an arrow Sc′ direction. Thus, an electrostatic latent image is formed on the second scanned surface 107b.

As described above, the light scanning apparatus 200 according to the present embodiment adopts a so-called opposing (both-side) scanning system in which the first and second light fluxes scan the respective first and second scanned surfaces 107a and 107b provided on sides that are opposed to each other (different from each other) with respect to the deflecting element unit 12.

Next, specification values, refractive indices and surface intervals of the respective optical elements, and lens surface shapes of the first incident optical element 103a and the first optical element 106a, of the light scanning apparatus 200 according to the present embodiment are shown in Table 4, Table 5, and Table 6 below, respectively.

In the light scanning apparatus 200 according to the present embodiment, the configurations of the first and second incident optical systems are symmetrical to each other with respect to the deflecting element 104, and the configurations of the first and second imaging optical systems are symmetrical to each other with respect to the deflecting element 104.

Accordingly, Table 4 to Table 6 show only the configurations of the first incident optical system and the first imaging optical system, and the configurations of the second incident optical system and the second imaging optical system are omitted.

The effect of the present embodiment described below can be obtained even when the configurations of the first and second incident optical systems are asymmetrical to each other and the configurations of the first and second imaging optical systems are asymmetrical to each other.

TABLE 4

| | Parameter | |
|---|---|---|
| Item | and Unit | Value |
| Angle between optical axis of first incident | Ψ [rad] | 1.571 |
| optical system and optical axis of first | | |
| imaging optical system | | |
| Scanning width on first scanned surface | h [mm] | 214 |
| 107a (distance between outermost off-axis | | |
| image heights) | | |
| Imaging coefficient at on-axis image height | KK [mm/rad] | 115.934 |
| Scanning characteristic coefficient | α [mm/rad³] | 16.858 |
| Maximum scanning angle | θmax [rad] | 0.838 |
| Number of deflecting surfaces 104a of | [Surface] | 4 |
| deflecting element 104 | | |
| Rotation center position in optical axis | Px [mm] | −5.89 |
| direction of deflecting element 104 | | |
| Rotation center position in main scanning | Py [mm] | −4.11 |
| direction of deflecting element 104 | | |
| Circumscribed circle radius in main | [mm] | 10 |
| scanning cross section of deflecting element | | |
| 104 | | |
| Diameter of first stop 102a (main scanning | Am × As | 1.644 × |
| direction × sub-scanning direction) | [mm × mm] | 1.606 |
| Optical path length between on-axis | Tc [mm] | 140 |
| deflection point on first deflecting surface | | |
| 104al and first scanned surface 107a | | |
| Reflection angle of first light flux by first | η [rad] | −1.571 |
| folding mirror 105a | | |
| Optical path length between on-axis | Dm [mm] | 241.757 |
| deflection point on first deflecting surface | | |
| 104a1 and natural convergence point of first | | |
| light flux | | |
| Focal length in main scanning cross section | fm [mm] | 189.425 |
| of first optical element 106a | | |
| Focal length in sub-scanning cross section | fs [mm] | 27.728 |
| of first optical element 106a | | |
| Optical path length between on-axis | DR2 [mm] | 41.863 |
| deflection point on first deflecting surface | | |
| 104al and exit surface of first optical | | |
| element 106a | | |

TABLE 5

| | | | Refractive | | | | | | |
|---|---|---|---|---|---|---|---|---|---|
| | | Surface | index | | | | | | |
| Surface | | interval | (λ = 790 | Coordinates of surface vertex | | | Direction cosine of optical axis | | |
| number | Optical surface | [mm] | nm) | tc(x) | tc(y) | tc(z) | gx(x) | gx(y) | gx(z) |
| 1 | First light source 101a | 0.250 | 1.511 | 0.000 | 46.500 | 0.000 | 0.000 | 1.000 | 0.000 |
| 2 | Glass cover for laser | 13.860 | 1.000 | 0.000 | 46.250 | 0.000 | 0.000 | 1.000 | 0.000 |
| | chip | | | | | | | | |
| 3 | First stop 102a | 3.720 | 1.000 | 0.000 | 32.390 | 0.000 | 0.000 | 1.000 | 0.000 |
| 4 | Incident surface of | 2.000 | 1.529 | 0.000 | 28.670 | 0.000 | 0.000 | 1.000 | 0.000 |
| | first incident optical | | | | | | | | |
| | element 103a | | | | | | | | |
| 5 | Exit surface of first | 26.670 | 1.000 | 0.000 | 26.670 | 0.000 | 0.000 | 1.000 | 0.000 |
| | incident optical | | | | | | | | |
| | element 103a | | | | | | | | |
| 6 | First deflecting | 10.000 | 1.000 | 0.000 | 0.000 | 0.000 | 0.707 | 0.707 | 0.000 |
| | surface 104a1 of | | | | | | | | |
| | deflecting element | | | | | | | | |
| | 104 (in on-axis light | | | | | | | | |
| | flux deflection) | | | | | | | | |
| 7 | First folding mirror | 18.800 | 1.000 | 10.000 | 0.414 | 0.000 | 0.707 | 0.000 | −0.707 |
| | 105a | | | | | | | | |
| 8 | Incident surface of | 13.063 | 1.529 | 10.000 | 0.414 | 18.800 | 0.000 | 0.000 | −1.000 |
| | first optical element | | | | | | | | |
| | 106a | | | | | | | | |
| 9 | Exit surface of first | 98.137 | 1.000 | 10.000 | 0.414 | 31.863 | 0.000 | 0.000 | −1.000 |
| | optical element 106a | | | | | | | | |
| 10 | First scanned surface 107a | — | 1.000 | 10.000 | 0.414 | 130.000 | 0.000 | 0.000 | −1.000 |

TABLE 6

| | Aspherical coefficient | | | | | | |
|---|---|---|---|---|---|---|---|
| | | First incident optical | | First optical element 106a | | | |
| | | element 103a | | Incident surface | | Exit surface | |
| | | Incident | Exit | Light source | Side opposite to | Light source | Side opposite to |
| | Coefficient | surface | surface | side | light source | side | light source |
| Meridional | R | ∞ | 3.3971E+01 | 1.7301E+03 | | 9.4915E+01 | |
| line | K | — | — | 1.9638E+03 | | 1.6218E−02 | |
| | B3 | — | — | −2.7203E−05 | | −2.1453E−05 | |
| | B4 | — | — | 3.7913E−06 | 2.0794E−06 | 1.9932E−06 | 1.1677E−06 |
| | B5 | — | — | — | — | — | — |
| | B6 | — | — | −3.0516E−09 | −3.3145E−09 | −1.9031E−10 | −5.8399E−10 |
| | B7 | — | — | — | — | — | — |
| | B8 | — | — | 2.2117E−12 | 3.0894E−12 | −1.9647E−13 | 4.3030E−14 |
| | B9 | — | — | — | — | — | — |
| | B10 | — | — | −5.5655E−16 | −8.5457E−16 | 2.8271E−16 | 3.1589E−16 |
| Sagittal line | r | ∞ | 1.2405E+01 | 1.1865E+02 | | 1.3545E+01 | |
| | E1 | — | — | −1.6656E−04 | | −5.4805E−05 | |
| | E2 | — | — | 1.3647E−05 | | −2.4677E−06 | |
| | E3 | — | — | 6.0024E−07 | | −3.8659E−08 | |
| | E4 | — | — | −8.5901E−08 | | −2.3624E−08 | |
| | E5 | — | — | −7.5942E−10 | | 3.7499E−10 | |
| | E6 | — | — | 5.3413E−11 | | 4.4882E−11 | |
| | E7 | — | — | 3.5871E−13 | | −3.9958E−13 | |
| | E8 | — | — | 3.9349E−15 | | −6.4169E−14 | |
| | E9 | — | — | — | | 1.3462E−16 | |
| | E10 | — | — | — | | 3.2216E−17 | |
| Additional | C3 | −2.5937E−02 | — | — | — | — | — |
| shape | C5 | −2.2164E−02 | — | — | — | — | — |

In the light scanning apparatus 200 according to the present embodiment, the first and second folding mirrors 105a and 105b reflect the respective incident first and second light fluxes toward the upper side in the sub-scanning direction, that is, toward the side on which the motor 104b and the motor substrate 104c are not arranged with respect to the deflecting element 104.

As described above, when the optical element 106 is arranged on the upper side in the sub-scanning direction with respect to the folding mirror 105, the mounting of each optical element in the housing 10 is facilitated.

Specifically, the housing 10 can be easily downsized in the main scanning cross section from the viewpoints of, for example, the width in the main scanning direction of an effective region of each optical element and a configuration of a support portion at the time of mounting each optical element from the upper side (opening portion) of the housing 10.

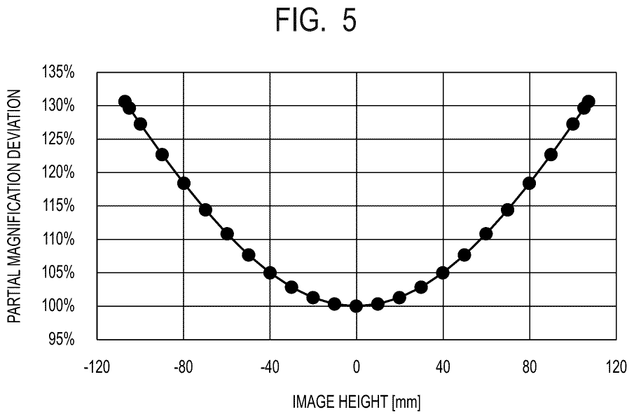

FIG. 5 shows partial magnification deviation at each image height in the light scanning apparatus 200 according to the present embodiment.

As shown in FIG. 5, in the light scanning apparatus 200 according to the present embodiment, the maximum partial magnification deviation, specifically, the partial magnification deviation of about 130.6% is caused at the outermost off-axis image height.

That is, in the light scanning apparatus 200 according to the present embodiment, similarly to the light scanning apparatus 100 according to the first embodiment, the scanning characteristic of the imaging optical system 85 is set so that the scanning speed at each off-axis image height becomes larger than the scanning speed at the on-axis image height.

As described above, in the light scanning apparatus 200 according to the present embodiment, the first and second incident optical elements 103a and 103b each have a positive refractive power in the main scanning cross section, and convert the respective incident first and second light fluxes into convergent light fluxes in the main scanning cross section.

Specifically, in the light scanning apparatus 200 according to the present embodiment, when the first and second imaging optical systems are not provided virtually, an optical path length Dₘ between the on-axis deflection point and a position at which the on-axis light flux is naturally converged in the main scanning cross section is about 241.8 mm.

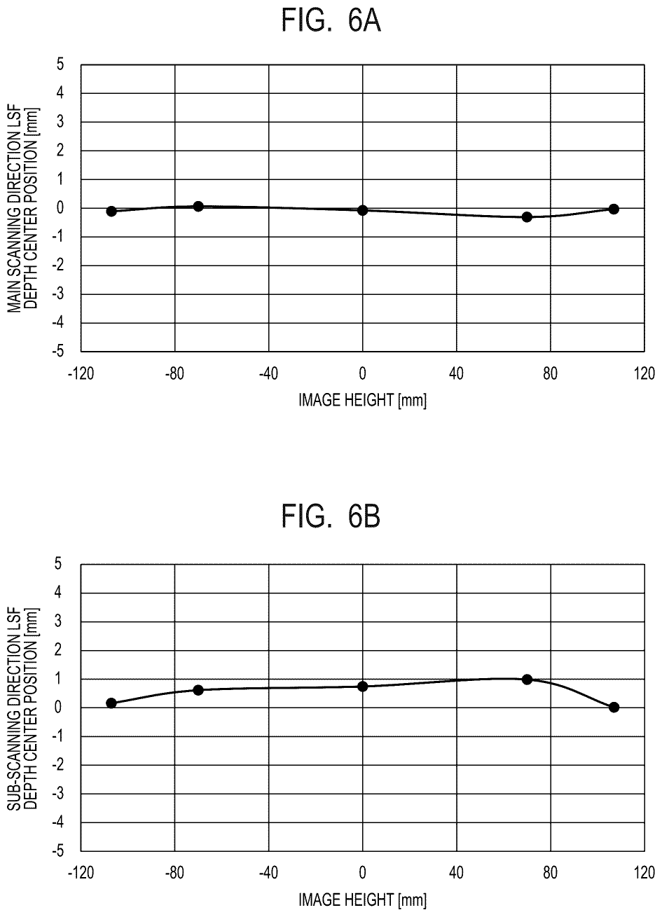

FIG. 6A and FIG. 6B show image height dependence of a main scanning direction LSF depth center position and a sub-scanning direction LSF depth center position, respectively, on the first scanned surface 107a in the light scanning apparatus 200 according to the present embodiment.

As shown in FIG. 6A and FIG. 6B, the main scanning direction LSF depth center position and the sub-scanning direction LSF depth center position both fall within ±1 mm over all image heights, and this shows that excellent imaging performance is achieved in the light scanning apparatus 200 according to the present embodiment.

In the light scanning apparatus 200 according to the present embodiment, as shown in Table 4, an optical path length T_{c1} (first optical path length) between the on-axis deflection point on the first deflecting surface 104a1 of the deflecting element 104 and the first scanned surface 107a along the optical axis of the first imaging optical system is equal to or less than a scanning width in the main scanning direction on the first scanned surface 107a, in other words, a distance h₁ (first distance) between the outermost off-axis image heights of the first scanned surface 107a.

Further, an optical path length T_{c2} (second optical path length) between the on-axis deflection point on the second deflecting surface 104a2 of the deflecting element 104 and the second scanned surface 107b along the optical axis of the second imaging optical system is equal to or less than a scanning width in the main scanning direction on the second scanned surface 107b, in other words, a distance h₂ (second distance) between the outermost off-axis image heights of the second scanned surface 107b.

In this manner, sufficient downsizing can be achieved in the light scanning apparatus 200 according to the present embodiment.

Further, in the light scanning apparatus 200 according to the present embodiment, it is preferred that Inequalities (8′) and (8″) below corresponding to Inequality (8) described above be satisfied.

$$0.5 \leq \frac{{T}_{c 1}}{{h}_{1}} \leq 1. \qquad ( 8 ’ )$$

$$0.5 \leq \frac{{T}_{c 2}}{{h}_{2}} \leq 1. \qquad ( 8 ” )$$

In the light scanning apparatus 200 according to the present embodiment, it is more preferred that Inequalities (8a′) and (8a″) below be satisfied.

$$0.5 \leq \frac{{T}_{c 1}}{{h}_{1}} \leq 0.7 \qquad ( 8 a ’ )$$

$$0.5 \leq \frac{{T}_{c 2}}{{h}_{2}} \leq 0.7 \qquad ( 8 a ” )$$

Further, in the light scanning apparatus 200 according to the present embodiment, it is preferred that Inequalities (9′) and (9″) below corresponding to Inequality (9) described above and Inequalities (10′) and (10″) below corresponding to Inequality (10) described above be satisfied.

Further, in the light scanning apparatus 200 according to the present embodiment, it is preferred that Inequalities (11′) and (11″) below corresponding to Inequality (11) described above be satisfied.

$$0.5 \leq \frac{{D}_{m 1}}{{T}_{c 1}} \leq 2.5 \qquad ( 9 ’ )$$

$$0.5 \leq \frac{{D}_{m 2}}{{T}_{c 2}} \leq 2.5 \qquad ( 9 ” )$$

$$0.05 \leq \frac{{f}_{s 1}}{{f}_{m 1}} \leq 0.25 \qquad ( 10 ’ )$$

$$0.05 \leq \frac{{f}_{s 2}}{{f}_{m 2}} \leq 0.25 \qquad ( 10 ” )$$

$$0.15 \leq \frac{{D}_{R 2 \_ 1}}{{T}_{c 1}} \leq 0.5 \qquad ( 11 ’ )$$

$$0.15 \leq \frac{{D}_{R 2 \_ 2}}{{T}_{c 2}} \leq 0.5 \qquad ( 11 ” )$$

In Inequality (9′), Dₘ₁ represents an optical path length between the on-axis deflection point on the first deflecting surface 104a1 and a position (first convergence point) at which the first light flux deflected by the first deflecting surface 104a1 is converged in the main scanning cross section when the first imaging optical system is not provided.

Further, in Inequality (9″), Dₘ₂ represents an optical path length between the on-axis deflection point on the second deflecting surface 104a2 and a position (second convergence point) at which the second light flux deflected by the second deflecting surface 104a2 is converged in the main scanning cross section when the second imaging optical system is not provided.

Further, in Inequality (10′), fₛ₁ and fₘ₁ represent focal lengths in the sub-scanning cross section and the main scanning cross section, respectively, of the first imaging optical system.

Further, in Inequality (10″), fₛ₂ and fₘ₂ represent focal lengths in the sub-scanning cross section and the main scanning cross section, respectively, of the second imaging optical system.

Further, in Inequality (11′), D_{R2_1} represents an optical path length between the on-axis deflection point on the first deflecting surface 104a1 and the exit surface of a predetermined optical element (second optical element), on the optical axis of the first imaging optical system.

The predetermined optical element referred to here is an optical element that is most spaced apart from the deflecting element unit 12 in the at least one optical element included in the first imaging optical system on the optical path of the first light flux deflected by the first deflecting surface 104a1.

That is, in the light scanning apparatus 200 according to the present embodiment, the predetermined optical element is the first optical element 106a.

Further, in Inequality (11″), D_{R2}_₂ represents an optical path length between the on-axis deflection point on the second deflecting surface 104a2 and the exit surface of a predetermined optical element (second optical element), on the optical axis of the second imaging optical system.

The predetermined optical element referred to here is an optical element that is most spaced apart from the deflecting element unit 12 in the at least one optical element included in the second imaging optical system on the optical path of the second light flux deflected by the second deflecting surface 104a2.

That is, in the light scanning apparatus 200 according to the present embodiment, the predetermined optical element is the second optical element 106b.

In the light scanning apparatus 200 according to the present embodiment, it is more preferred that Inequalities (9a′), (9a″), (10a′), (10a″), (11a′), and (11a″) below be satisfied.

$$1. \leq \frac{{D}_{m 1}}{{T}_{c 1}} \leq 2.2 \qquad ( 9 a ’ )$$

$$1. \leq \frac{{D}_{m 2}}{{T}_{c 2}} \leq 2.2 \qquad ( 9 a ” )$$

$$0.05 \leq \frac{{f}_{s 1}}{{f}_{m 1}} \leq 0.2 \qquad ( 10 a ’ )$$

$$0.05 \leq \frac{{f}_{s 2}}{{f}_{m 2}} \leq 0.2 \qquad ( 10 a ” )$$

$$0.17 \leq \frac{{D}_{R 2 \_ 1}}{{T}_{c 1}} \leq 0.4 \qquad ( 11 a ’ )$$

$$0.17 \leq \frac{{D}_{R 2 \_ 2}}{{T}_{c 2}} \leq 0.4 \qquad ( 11 a ” )$$

Further, in the light scanning apparatus 200 according to the present embodiment, it is preferred that Inequalities (12′) and (12″) below corresponding to Inequality (12) described above be satisfied.

$$110. \leq \vert Δ {Y}_{1} \vert \leq 140. \qquad ( 12 ’ )$$

$$110. \leq \vert Δ {Y}_{2} \vert \leq 140. \qquad ( 12 ” )$$

In Inequality (12′), ΔY₁ (%) represents a value of a ratio of a partial magnification at the outermost off-axis image height to the partial magnification at the on-axis image height on the first scanned surface 107a.

Further, in Inequality (12″), ΔY₂ (%) represents a value of a ratio of a partial magnification at the outermost off-axis image height to the partial magnification at the on-axis image height on the second scanned surface 107b.

In the light scanning apparatus 200 according to the present embodiment, it is more preferred that Inequalities (12a′) and (12a″) below be satisfied.

$$120. \leq \vert Δ {Y}_{1} \vert \leq 135. \qquad ( 12 a ’ )$$

$$120. \leq \vert Δ {Y}_{2} \vert \leq 135. \qquad ( 12 a ” )$$

In the light scanning apparatus 200 according to the present embodiment, T_{c1}/h₁=T_{c2}/h₂=0.65 is satisfied, and thus Inequalities (8′), (8a′), (8″), and (8a″) are satisfied.

Further, in the light scanning apparatus 200 according to the present embodiment, Dₘ₁/T_{c1}=Dₘ₂/T_{c2}=1.73 is satisfied, and thus Inequalities (9′), (9a′), (9″), and (9a″) are satisfied.

Further, in the light scanning apparatus 200 according to the present embodiment, fₛ₁/fₘ₁=fₛ₂/fₘ₂=0.15 is satisfied, and thus Inequalities (10′), (10a′), (10″), and (10a″) are satisfied.

Further, in the light scanning apparatus 200 according to the present embodiment, D_{R2_1}/T_{c1}=D_{R2_2}/T_{c2}=0.30 is satisfied, and thus Inequalities (11′), (11a′), (11″), and (11a″) are satisfied.

Further, in the light scanning apparatus 200 according to the present embodiment, |ΔY₁|=|ΔY₂|=130.6% is satisfied, and thus Inequalities (12′), (12a′), (12″), and (12a″) are satisfied.

As described above, in the light scanning apparatus 200 according to the present embodiment, the first folding mirror 105a is arranged between the deflecting element unit 12 and the first optical element 106a that is closest to the deflecting element unit 12 in the first imaging optical system.

Further, the second folding mirror 105b is arranged between the deflecting element unit 12 and the second optical element 106b that is closest to the deflecting element unit 12 in the second imaging optical system, and thus Inequalities (8′) and (8″) are satisfied.

In this manner, the light scanning apparatus 200 sufficiently downsized by reducing the optical path of each of the first and second light fluxes that scan both sides across the deflecting element unit 12 can be provided.

### Third Embodiment

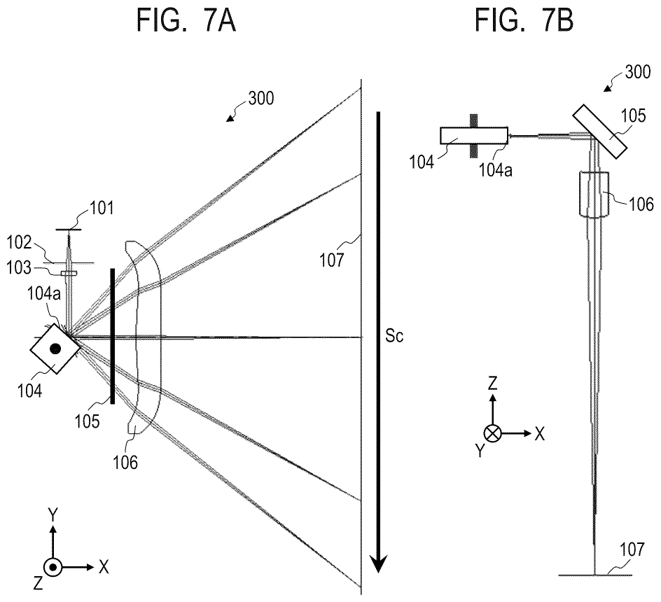

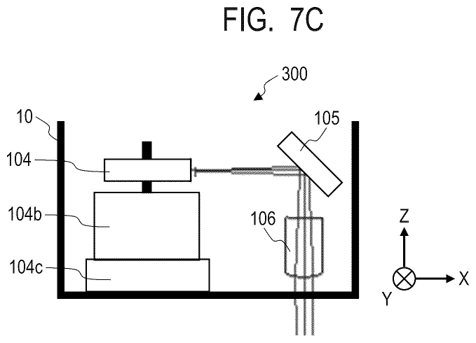

FIG. 7A shows a schematic developed view in a main scanning cross section of a light scanning apparatus 300 according to a third embodiment of the present invention.

Each of FIG. 7B and FIG. 7C show a schematic partial sub-scanning cross sectional view of the light scanning apparatus 300 according to the third embodiment.

The light scanning apparatus 300 according to the present embodiment has the same configuration as that of the light scanning apparatus 100 according to the first embodiment, except for differences in specification values. Accordingly, the same members are denoted by the same reference numbers, and descriptions thereof are omitted.

Specification values, refractive indices and surface intervals of the respective optical elements, and lens surface shapes of the incident optical element 103 and the optical element 106, of the light scanning apparatus 300 according to the present embodiment are shown in Table 7, Table 8, and Table 9 below, respectively.

TABLE 7

| Item | Parameter and Unit | Value |
|---|---|---|
| Angle between optical axis of incident | Ψ [rad] | 1.571 |
| optical system 75 and optical axis of | | |
| imaging optical system 85 | | |
| Scanning width on scanned surface 107 | h [mm] | 214 |
| (distance between outermost off-axis | | |
| image heights) | | |
| Imaging coefficient at on-axis image | KK [mm/rad] | 115.962 |
| height | | |
| Scanning characteristic coefficient | α [mm/rad³] | 17.018 |
| Maximum scanning angle | θmax [rad] | 0.838 |
| Number of deflecting surfaces 104a of | [Surface] | 4 |
| deflecting element 104 | | |
| Rotation center position in optical axis | Px [mm] | −5.89 |
| direction of deflecting element 104 | | |
| Rotation center position in main | Py [mm] | −4.11 |
| scanning direction of deflecting element | | |
| 104 | | |
| Circumscribed circle radius in main | [mm] | 10 |
| scanning cross section of deflecting | | |
| element 104 | | |
| Diameter of stop 102 (main scanning | Am × As | 2.000 × |
| direction × sub-scanning direction) | [mm × mm] | 1.000 |
| Optical path length between on-axis | Tc[mm] | 125 |
| deflection point and scanned surface | | |
| 107 | | |
| Reflection angle of light flux by folding | η [rad] | 1.571 |
| mirror 105 | | |
| Optical path length between on-axis | Dm [mm] | 157.759 |
| deflection point and natural | | |
| convergence point | | |
| Focal length in main scanning cross | fm [mm] | 334.797 |
| section of optical element 106 | | |
| Focal length in sub-scanning cross | fs [mm] | 26.675 |
| section of optical element 106 | | |
| Optical path length between on-axis | DR2 [mm] | 39.481 |
| deflection point and exit surface of | | |
| optical element 106 | | |

TABLE 8

| | | Surface | Refractive | | | | | | |
|---|---|---|---|---|---|---|---|---|---|
| Surface | | interval | index | Coordinates of surface vertex | | | Direction cosine of optical axis | | |
| number | Optical surface | [mm] | (λ = 790 nm) | tc(x) | tc(y) | tc(z) | gx(x) | gx(y) | gx(z) |
| 1 | Light source 101 | 0.250 | 1.511 | 0.000 | 46.500 | 0.000 | 0.000 | 1.000 | 0.000 |
| 2 | Glass cover for | 13.860 | 1.000 | 0.000 | 46.250 | 0.000 | 0.000 | 1.000 | 0.000 |
| | laser chip | | | | | | | | |
| 3 | Stop 102 | 3.720 | 1.000 | 0.000 | 32.390 | 0.000 | 0.000 | 1.000 | 0.000 |
| 4 | Incident surface | 2.000 | 1.529 | 0.000 | 28.670 | 0.000 | 0.000 | 1.000 | 0.000 |
| | of incident | | | | | | | | |
| | optical element 103 | | | | | | | | |
| 5 | Exit surface of | 26.670 | 1.000 | 0.000 | 26.670 | 0.000 | 0.000 | 1.000 | 0.000 |
| | incident optical | | | | | | | | |
| | element 103 | | | | | | | | |
| 6 | Deflecting | 20.000 | 1.000 | 0.000 | 0.000 | 0.000 | 0.707 | 0.707 | 0.000 |
| | surface 104a of | | | | | | | | |
| | deflecting | | | | | | | | |
| | element 104 | | | | | | | | |
| | (in on-axis light | | | | | | | | |
| | flux deflection) | | | | | | | | |
| 7 | Folding mirror 105 | 8.800 | 1.000 | 20.000 | 0.075 | 0.000 | 0.707 | 0.000 | 0.707 |
| 8 | Incident surface | 10.681 | 1.529 | 20.000 | 0.075 | −8.800 | 0.000 | 0.000 | 1.000 |
| | of optical | | | | | | | | |
| | element 106 | | | | | | | | |
| 9 | Exit surface of | 85.519 | 1.000 | 20.000 | 0.075 | −19.481 | 0.000 | 0.000 | 1.000 |
| | optical element 106 | | | | | | | | |
| 10 | Scanned surface 107 | — | 1.000 | 20.000 | 0.075 | −105.000 | 0.000 | 0.000 | 1.000 |

TABLE 9

| | Aspherical coefficient | | | | | | |
|---|---|---|---|---|---|---|---|
| | | | | Optical element 106 | | | |
| | | | | Incident surface | | Exit surface | |
| | | Incident optical element 103 | | | Side | | Side |
| | | Incident | Exit | Light source | opposite to | Light source | opposite to |
| | Coefficient | surface | surface | side | light source | side | light source |
| Meridional | R | ∞ | 3.0632E+01 | −1.7272E+02 | | −6.9876E+03 | |
| line | K | — | — | 3.2549E−01 | | 2.3763E+04 | |
| | B3 | — | — | −1.3526E−05 | | −9.7153E−06 | |
| | B4 | — | — | −6.8772E−08 | −7.1840E−07 | −1.6507E−06 | −1.6453E−06 |
| | B5 | — | — | — | — | — | — |
| | B6 | — | — | 7.1384E−09 | 5.8241E−09 | 6.1504E−09 | 4.4691E−09 |
| | B7 | — | — | — | — | — | — |
| | B8 | — | — | −3.2516E−12 | −2.1709E−12 | −2.9411E−12 | −1.6522E−12 |
| | B9 | — | — | — | — | — | — |
| | B10 | — | — | 4.7295E−16 | 1.3521E−16 | 7.7490E−16 | 3.6783E−16 |
| Sagittal | r | ∞ | 1.2405E+01 | 1.8302E+01 | | 9.5727E+00 | |
| line | E1 | — | — | 8.5726E−05 | | 6.6252E−05 | |
| | E2 | — | — | −1.2247E−04 | | −7.3110E−05 | |
| | E3 | — | — | −3.8495E−07 | | −2.4334E−07 | |
| | E4 | — | — | 3.9047E−08 | | −1.2599E−09 | |
| | E5 | — | — | 6.4112E−10 | | 5.0240E−10 | |
| | E6 | — | — | 2.0036E−13 | | 4.9125E−11 | |
| | E7 | — | — | −2.0866E−13 | | −3.3588E−13 | |
| | E8 | — | — | 4.1266E−15 | | −4.1857E−14 | |
| | E9 | — | — | — | | 1.2377E−16 | |
| | E10 | — | — | — | | −4.1857E−14 | |
| Additional | C3 | −2.5937E−02 | — | — | — | — | — |
| shape | C5 | −2.2164E−02 | — | — | — | — | — |

In the light scanning apparatus 300 according to the present embodiment, as illustrated in FIG. 7C, the folding mirror 105 reflects the incident light flux toward a lower side in the sub-scanning direction, that is, toward a side on which the motor 104b and the motor substrate 104c are arranged with respect to the deflecting element 104.

In this manner, the optical element 106 can be arranged in an inefficient space formed by not the deflecting element 104 but the motor 104b and the motor substrate 104c in the deflecting element unit 12.

That is, the light scanning apparatus 300 according to the present embodiment can be downsized in the sub-scanning cross section.

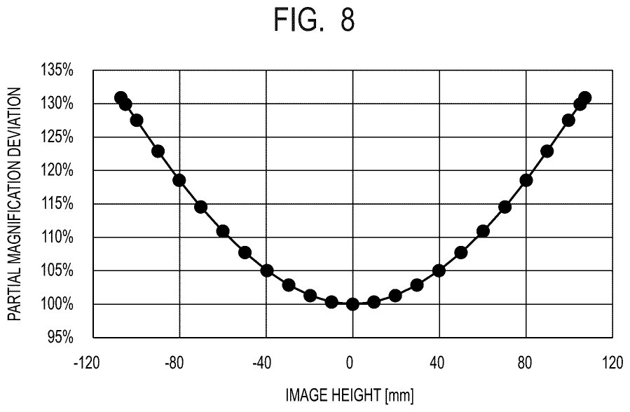

FIG. 8 shows partial magnification deviation at each image height in the light scanning apparatus 300 according to the present embodiment.

As shown in FIG. 8, in the light scanning apparatus 300 according to the present embodiment, the maximum partial magnification deviation, specifically, the partial magnification deviation of about 130.9% is caused at the outermost off-axis image height.

That is, in the light scanning apparatus 300 according to the present embodiment, similarly to the light scanning apparatus 100 according to the first embodiment, the scanning characteristic of the imaging optical system 85 is set so that the scanning speed at each off-axis image height becomes larger than the scanning speed at the on-axis image height.

As described above, in the light scanning apparatus 300 according to the present embodiment, the incident optical element 103 has a positive refractive power in the main scanning cross section, and converts the incident light flux into a convergent light flux in the main scanning cross section.

Specifically, in the light scanning apparatus 300 according to the present embodiment, when the imaging optical system 85 is not provided virtually, an optical path length Dₘ between the on-axis deflection point and a position at which the on-axis light flux is naturally converged in the main scanning cross section is about 157.8 mm.

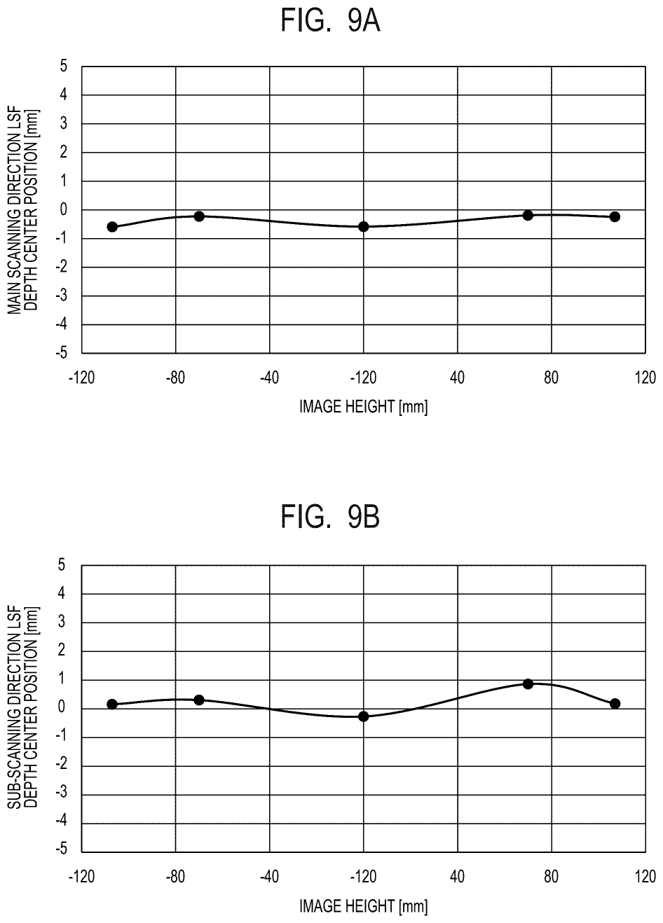

FIG. 9A and FIG. 9B show image height dependence of the main scanning direction LSF depth center position and the sub-scanning direction LSF depth center position, respectively, on the scanned surface 107 in the light scanning apparatus 300 according to the present embodiment.

As shown in FIG. 9A and FIG. 9B, the main scanning direction LSF depth center position and the sub-scanning direction LSF depth center position both fall within ±1 mm over all image heights, and this shows that excellent imaging performance is achieved in the light scanning apparatus 300 according to the present embodiment.

In the light scanning apparatus 300 according to the present embodiment, as shown in Table 7, an optical path length T_{c} (first optical path length) between the on-axis deflection point on the deflecting surface 104a of the deflecting element 104 and the scanned surface 107 along the optical axis of the imaging optical system 85 is equal to or less than a scanning width in the main scanning direction on the scanned surface 107, in other words, a distance “h” (first distance) between the outermost off-axis image heights of the scanned surface 107.

In this manner, sufficient downsizing can be achieved in the light scanning apparatus 300 according to the present embodiment.

Further, in the light scanning apparatus 300 according to the present embodiment, T_{c}/h=0.58, Dₘ/T_{c}=1.26, and fₛ/fₘ=0.08 are satisfied, and thus Inequalities (8), (8a), (9), (9a), (10), and (10a) are satisfied.

Further, in the light scanning apparatus 300 according to the present embodiment, D_{R2}/T_{c}=0.32 and |ΔY|=130.9% are satisfied, and thus Inequalities (11), (11a), (12), and (12a) are satisfied.

As described above, in the light scanning apparatus 300 according to the present embodiment, the folding mirror 105 is arranged between the deflecting element unit 12 and the optical element 106 that is closest to the deflecting element unit 12 in the imaging optical system 85, and Inequality (8) is satisfied.

In this manner, the light scanning apparatus 300 that is sufficiently downsized by reducing the optical path can be provided.

Numerical values corresponding to the respective Inequalities in each of the light scanning apparatuses according to the first to third embodiments are shown in Table 10 below.

TABLE 10

| Numerical values | First | Second | Third |
|---|---|---|---|
| and Inequalities | embodiment | embodiment | embodiment |
| Tc [mm] | 125 | 140 | 125 |
| h [mm] | 214 | 214 | 214 |
| Dm [mm] | 229.027 | 241.757 | 157.759 |
| fs [mm] | 21.081 | 27.728 | 26.675 |
| fm [mm] | 194.026 | 189.425 | 334.797 |
| DR2 [mm] | 28.800 | 41.863 | 39.481 |
| Inequality (8): | 0.58 | 0.65 | 0.58 |
| 0.50 ≤ Tc/h ≤ 1.00 | | | |
| Inequality (8a): | | | |
| 0.50 ≤ Tc/h ≤ 0.70 | | | |
| Inequality (9): | 1.83 | 1.73 | 1.26 |
| 0.50 ≤ Dm/Tc ≤ 2.50 | | | |
| Inequality (9a): | | | |
| 1.00 ≤ Dm/Tc ≤ 2.20 | | | |
| Inequality (10): | 0.11 | 0.15 | 0.08 |
| 0.05 ≤ fs/fm ≤ 0.25 | | | |
| Inequality (10a): | | | |
| 0.05 ≤ fs/fm ≤ 0.20 | | | |
| Inequality (11): | 0.23 | 0.30 | 0.32 |
| 0.15 ≤ DR2/Tc ≤ 0.50 | | | |
| Inequality (11a): | | | |
| 0.17 ≤ DR2/Tc ≤ 0.40 | | | |
| Inequality (12): | 130.6 | 130.6 | 130.9 |
| 110.0 ≤ \|ΔY\| ≤ 140.0 | | | |
| Inequality (12a): | | | |
| 120.0 ≤ \|ΔY\| ≤ 135.0 | | | |

Exemplary embodiments have been described above, but the present invention is not limited to those embodiments, and various modifications and changes can be made thereto without departing from the gist thereof.

According to the present embodiments, a sufficiently-down sized light scanning apparatus can be provided.

### [Image Forming Apparatus]

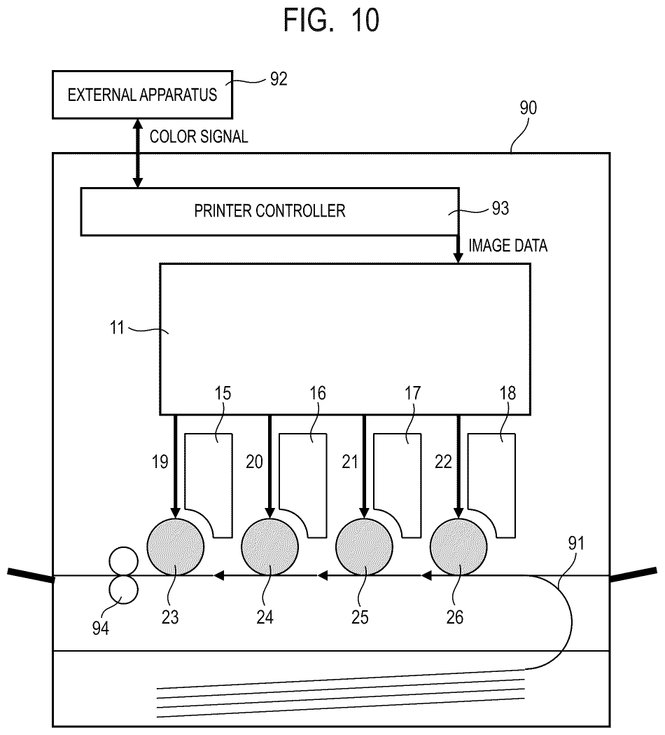

FIG. 10 shows a sub-scanning cross sectional view of a main part of an image forming apparatus 90 including the light scanning apparatus according to any one of the first to third embodiments of the present invention.

The image forming apparatus 90 is a tandem-type color image forming apparatus in which a light scanning unit 11 records image information on surfaces of a plurality of photosensitive drums each of which is an image bearing member.

The image forming apparatus 90 includes the light scanning unit 11, developing units 15, 16, 17, and 18, photosensitive drums 23, 24, 25, and 26, a conveying belt 91, a printer controller 93, and a fixing unit 94.

The light scanning unit 11 can include, for example, four light scanning apparatus according to the first or third embodiment, or two light scanning apparatus according to the second embodiment.

As illustrated in FIG. 10, color signals of red (R), green (G), and blue (B) output from an external apparatus 92 such as a personal computer are input to the image forming apparatus 90.

Those input color signals are then converted into pieces of image data (dot data) on cyan (C), magenta (M), yellow (Y), and black (K) by the printer controller 93 included in the image forming apparatus 90.

Then, the pieces of image data generated by the conversion are input to the light scanning unit 11.

Light beams 19, 20, 21, and 22 modulated based on the respective pieces of image data are emitted from the light scanning unit 11, and photosensitive surfaces of the photosensitive drums 23, 24, 25, and 26 are scanned with the respective light beams 19, 20, 21, and 22 in the main scanning direction.

Charging rollers (not shown) for uniformly charging the respective surfaces of the photosensitive drums 23, 24, 25, and 26 are provided so as to be brought into abutment against the surfaces. In addition, the light scanning unit 11 irradiates, with the light beams 19, 20, 21, and 22, the respective surfaces of the photosensitive drums 23, 24, 25, and 26 charged by the charging rollers.

As described above, the light beams 19, 20, 21, and 22 have been modulated based on the pieces of image data of the respective colors, and electrostatic latent images are formed on the respective surfaces of the photosensitive drums 23, 24, 25, and 26 by irradiating the respective surfaces with the light beams 19, 20, 21, and 22. The formed electrostatic latent images are developed as toner images by the developing units 15, 16, 17, and 18 arranged so as to abut against the photosensitive drums 23, 24, 25, and 26, respectively.

The toner images developed by the developing units 15, 16, 17, and 18 are transferred onto a sheet (a transferred material) (not shown) being conveyed on the conveying belt 91 in a superimposed manner by transferring rollers (transferring unit) (not shown) arranged so as to be opposed to the photosensitive drums 23, 24, 25, and 26. One full-color image is thus formed on the sheet.

In the manner described above, the sheet onto which the unfixed toner images have been transferred is further conveyed to the fixing unit 94 provided on a rear side (on the left side of FIG. 10) of the photosensitive drums 23, 24, 25, and 26.

The fixing unit 94 includes a fixing roller containing a fixing heater (not shown) therein, and a pressurizing roller arranged so as to be brought into pressure contact with the fixing roller. The unfixed toner images on the sheet conveyed from a transferring portion are fixed by heating, under pressure applied from a pressure contact portion between the fixing roller and the pressurizing roller. A discharging roller (not shown) is further provided on a rear side of the fixing roller, and discharge the sheet onto which the toner images have been fixed to the outside of the image forming apparatus 90.

As the external apparatus 92, for example, a color image reading apparatus including a CCD sensor may be used. In this case, this color image reading apparatus and the image forming apparatus 90 form a color digital copying machine.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-197828, filed Nov. 22, 2023, which is hereby incorporated by reference herein in its entirety.

What is claimed is:

1. Alight scanning apparatus comprising:
a deflecting unit configured to deflect a first light flux from a first light source to scan a first scanned surface in a main scanning direction;
a first imaging optical system including at least one optical element configured to guide the first light flux deflected by a first deflecting surface of the deflecting unit to the first scanned surface; and
a first reflecting element configured to reflect the first light flux,
wherein, on an optical path of the first light flux from the deflecting unit to the first scanned surface, the first reflecting element is arranged between the deflecting unit and a first optical element closest to the deflecting unit among the at least one optical element included in the first imaging optical system, and
wherein a first optical path length between a first on-axis deflection point of the first deflecting surface and the first scanned surface on an optical axis of the first imaging optical system is equal to or less than a first distance between outermost off-axis image heights on the first scanned surface.

2. The light scanning apparatus according to claim 1, wherein the following condition is satisfied:
$$0.5 \leq {T}_{c 1} / {h}_{1} \leq 1. ,$$
where T_{c1} represents the first optical path length and h₁ represents the first distance.

3. The light scanning apparatus according to claim 1, further comprising a first incident optical system configured to convert the first light flux from the first light source into a convergent light flux in a main scanning cross section to cause the convergent light flux to be incident on the first deflecting surface.

4. The light scanning apparatus according to claim 3, wherein the first incident optical system includes a first incident optical element configured to convert the first light flux from the first light source into the convergent light flux in the main scanning cross section and condense the first light flux in a sub-scanning cross section.

5. The light scanning apparatus according to claim 1, wherein the following condition is satisfied:
$$0.5 \leq {D}_{m 1} / {T}_{c 1} \leq 2.5 ,$$
where Dₘ₁ represents an optical path length between the first on-axis deflection point and a first convergence point at which the first light flux deflected by the first deflecting surface is converged in a main scanning cross section when the first imaging optical system is not provided.

6. The light scanning apparatus according to claim 1, wherein the following condition is satisfied:
$$0.05 \leq {f}_{s 1} / {f}_{m 1} \leq 0.25 ,$$
where fₛ₁ and fₘ₁ represent focal lengths in a sub-scanning cross section and a main scanning cross section of the first imaging optical system, respectively.

7. The light scanning apparatus according to claim 1, wherein the following condition is satisfied:
$$0.15 \leq {D}_{R 2 \_ 1} / {T}_{c 1} \leq 0.5 ,$$
where D_{R2_1} represents an optical path length between the first on-axis deflection point and an exit surface of a second optical element which is most spaced apart from the deflecting unit among the at least one optical element included in the first imaging optical system, on the optical axis of the first imaging optical system.

8. The light scanning apparatus according to claim 1, wherein a scanning speed of the first light flux on the first scanned surface increases monotonically from an on-axis image height toward the outermost off-axis image height.

9. The light scanning apparatus according to claim 8, wherein the following condition is satisfied:
$$110. \leq Δ {Y}_{1} \leq 140. ,$$
where ΔY₁ (%) represents a value of a ratio of a partial magnification at the outermost off-axis image height to the partial magnification at the on-axis image height.

10. The light scanning apparatus according to claim 1, further comprising:
a second imaging optical system including at least one optical element configured to guide a second light flux deflected by a second deflecting surface of the deflecting unit to a second scanned surface; and
a second reflecting element configured to reflect the second light flux,
wherein, on an optical path of the second light flux from the deflecting unit to the second scanned surface, the second reflecting element is arranged between the deflecting unit and a third optical element closest to the deflecting unit among the at least one optical element included in the second imaging optical system,
wherein the deflecting unit is configured to deflect the second light flux from the second light source to scan the second scanned surface in the main scanning direction, and
wherein a second optical path length between a second on-axis deflection point of the second deflecting surface and the second scanned surface on an optical axis of the second imaging optical system is equal to or less than a second distance between outermost off-axis image heights on the second scanned surface.

11. The light scanning apparatus according to claim 10, wherein the following condition is satisfied:
$$0.5 \leq {T}_{c 2} / {h}_{2} \leq 1. ,$$
where T_{c2} represents the second optical path length and h₂ represents the second distance.

12. The light scanning apparatus according to claim 1,
wherein the deflecting unit includes a deflecting element having a plurality of deflecting surfaces, and a driving unit configured to rotate the deflecting element about a rotational axis, and
wherein the first light flux deflected by the first deflecting surface is reflected by the first reflecting element to a side on which the driving unit is arranged with respect to the deflecting element in a sub-scanning direction.

13. The light scanning apparatus according to claim 1, wherein the first imaging optical system consists of the first optical element.

14. The light scanning apparatus according to claim 1, wherein any reflecting element other than the first reflecting element is not arranged on the optical path of the first light flux from the deflecting unit to the first scanned surface.

15. An image forming apparatus comprising:
the light scanning apparatus of claim 1;
a developing unit configured to develop, as a toner image, an electrostatic latent image formed by the light scanning apparatus on the first scanned surface;
a transferring unit configured to transfer the developed toner image onto a transferred material; and
a fixing unit configured to fix the transferred toner image to the transferred material.

16. An image forming apparatus comprising:
the light scanning apparatus of claim 1; and
a printer controller configured to convert a signal output from an external apparatus into image data to input the image data to the light scanning apparatus.
